(19) United States
(12) Patent Application Publication
(10) Pub. No.: US 2015/0208354 A1
(43) Pub. Date: Jul. 23, 2015

(54) SYSTEM AND METHOD FOR EXTENDING BATTERY LIFE OF A MOBILE DEVICE PROVIDING CONTENT WIRELESSLY TO A REMOTE DISPLAY

(71) Applicant: Nvidia Corporation, Santa Clara, CA (US)

(72) Inventors: Ravindra Lokhande, Pune (IN); Nikesh Oswal, Pune (IN)

(73) Assignee: Nvidia Corporation, Santa Clara, CA (US)

(21) Appl. No.: 14/162,534

(22) Filed: Jan. 23, 2014

(51) Int. Cl. H04W 52/02; H04W 4/20; H04M 1/725

(52) U.S. Cl. CPC H04W 52/0258; H04M 1/7253; H04W 4/20

(57) ABSTRACT

A system for, and method of, extending the battery life of a mobile device providing content wirelessly and a mobile device incorporating the system or the method. In one embodiment, the system includes: (1) a power manager operable to generate a signal indicating that a low battery condition exists and (2) an audio/video subsystem operable to receive the signal and adjust at least one parameter controlling an encoding of the content to decrease a quality of the encoding.

### TECHNICAL FIELD

This application is directed, in general, to a mobile devices and, more specifically, to mobile devices having the ability to provide content wirelessly to a remote display.

### BACKGROUND

Mobile devices such as cellphones, smartphones, tablets and laptops are ubiquitous. While they were originally introduced to provide rudimentary functionality, such as telephony and text messaging, they have now evolved to the point that they have begun to replicate the functions of physically much larger computers, such as desktop personal computers. Accordingly, mobile devices are beginning to be used for gaming, desktop publishing and graphics and video editing. These are particularly computation- and graphics-intensive applications, and test the general- and special-purpose processing and storage limits of mobile devices.

Supporting the ever-intensifying use of mobile devices is an evermore-capable wireless network infrastructure, making its presence known in both cellular and wireless Internet access (Wi-Fi) forms. Consequently, mobile devices are able to make higher-bandwidth, more reliable wireless connections in more places than ever before possible.

As a result of all of the above, more-capable mobile devices (smartphones and tablets in particular) have begun to spawn short-range wireless networks of their own, allowing other devices to be “tethered” to the more-capable mobile devices, which then serve as proxies for access to the wireless network infrastructure. Bluetooth and Wi-Fi Direct are two notable technologies that make possible such short-range peer-to-peer wireless networks, sometimes called personal area networks (PANs) or piconets. Not only can two smartphones, pads and tablets be tethered to one another via Bluetooth or Wi-Fi Direct, but a host of less-capable devices can be tethered as well, such as cell phones, earphones, headsets, speakers, displays, gaming controllers and remotes, sensors and actuators, to name just a few.

### SUMMARY

One aspect provides a system for extending the battery life of a mobile device providing content wirelessly. In one embodiment, the system includes: (1) a power manager operable to generate a signal indicating that a low battery condition exists and (2) an audio/video subsystem operable to receive the signal and adjust at least one parameter controlling an encoding of the content to decrease a quality of the encoding.

Another aspect provides a method of extending the battery life of a mobile device providing content wirelessly. In one embodiment, the method includes: (1) initially setting at least one parameter controlling an encoding of the content at a relatively high level of quality, (2) detecting when a low battery condition exists and (3) in response to the detecting, adjusting the least one parameter to decrease the quality.

Yet another embodiment provides a mobile device. In one embodiment, the mobile device includes: (1) a local display, (2) a wireless network interface operable to provide audio and video content wirelessly to a remote display, (3) a processor coupled to the local display and the wireless network interface, (4) a memory subsystem coupled to the processor, (5) a power manager coupled to the processor and operable to generate a signal indicating that a low battery condition exists and (6) an audio/video subsystem operable to provide the audio and video content to the wireless network interface, receive the signal and adjust at least one parameter controlling an encoding of the video and audio content to decrease a quality of the encoding.

### BRIEF DESCRIPTION

Reference is now made to the following descriptions taken in conjunction with the accompanying drawings, in which:

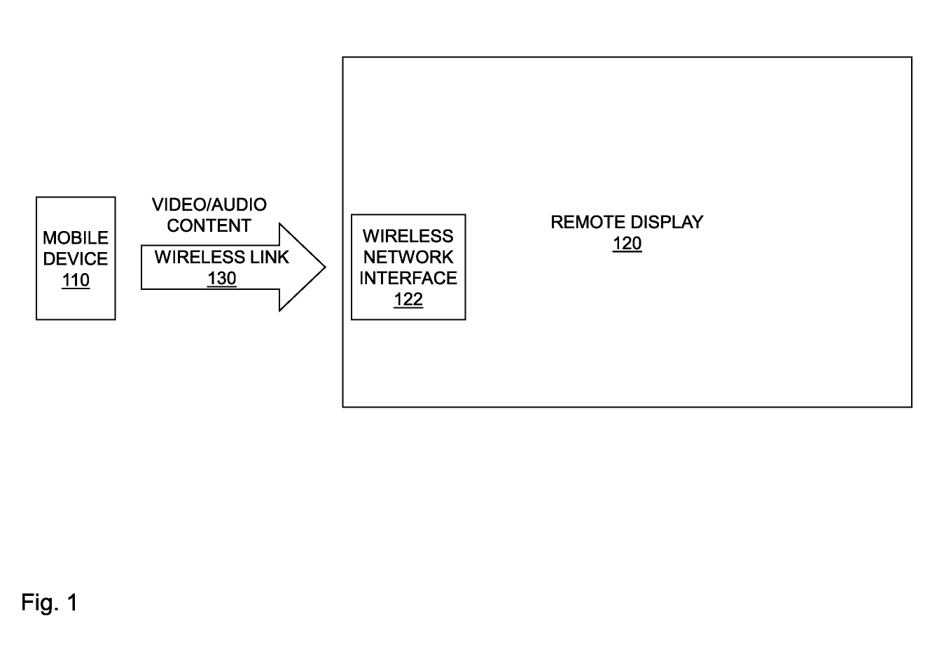

FIG. 1 is a block diagram illustrating a mobile device providing content wirelessly to a remote display;

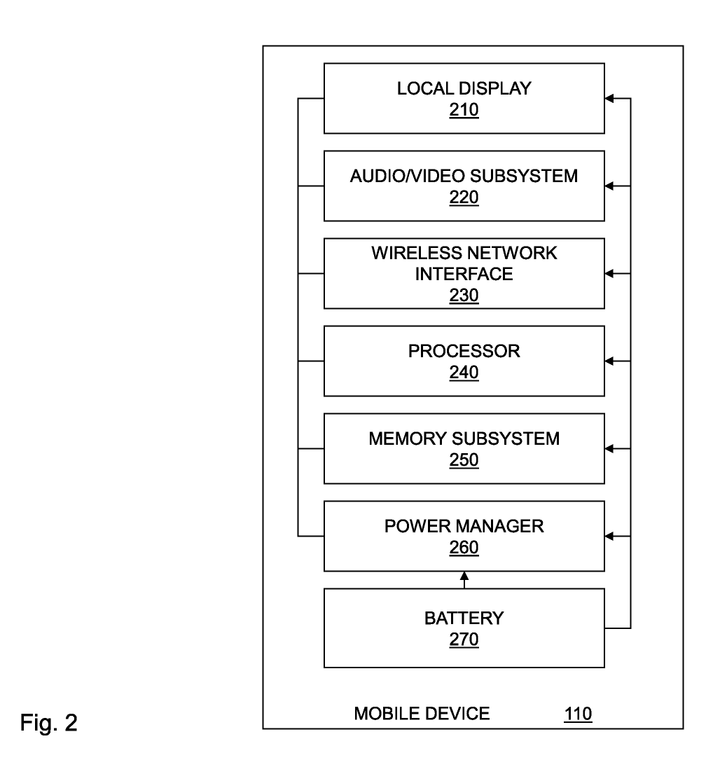

FIG. 2 is a high-level block diagram of one embodiment of a mobile device incorporating a system for extending the battery life of a mobile device that is providing content wirelessly; and

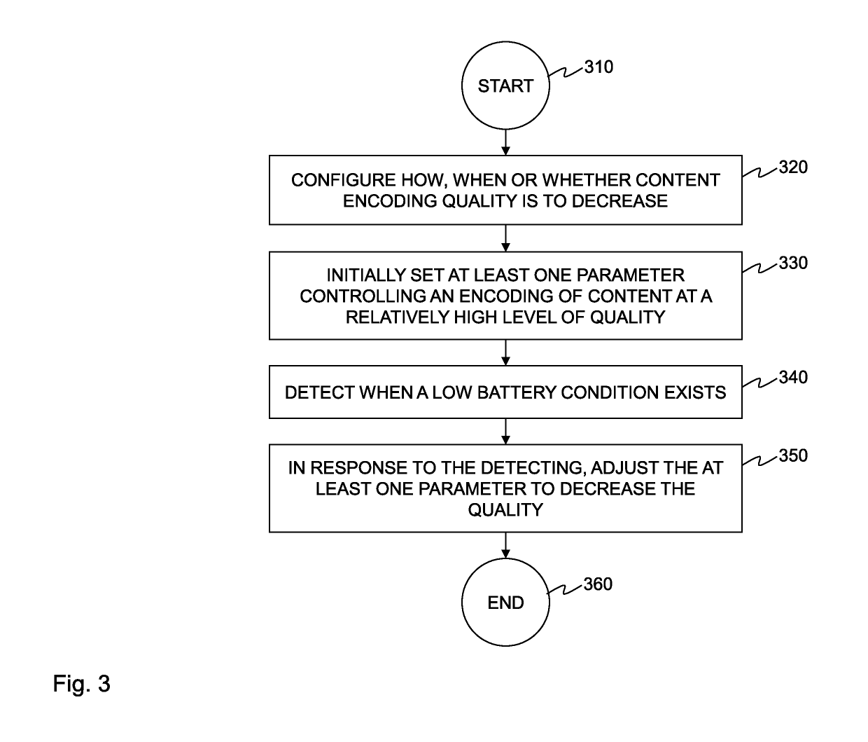

FIG. 3 is a flow diagram of one embodiment of a method of extending the battery life of a mobile device that is providing content wirelessly.

### DETAILED DESCRIPTION

As stated above, not only can two smartphones or tablets be tethered to one another via Bluetooth or Wi-Fi Direct, but a host of less-capable devices can be tethered as well, such as feature (cell) phones, earphones, headsets, speakers, displays, gaming controllers and remotes, sensors and actuators, to name just a few. One fascinating technology allows a remote display, such as a television set, to be tethered to a mobile device. In one form, this technology is known as Miracast™, which is a peer-to-peer wireless screencast standard formed via Wi-Fi Direct connections in a manner similar to Bluetooth.

With Miracast™ or analogous technologies, the mobile device can then wirelessly provide the content (video, audio or both video and audio) it normally displays only locally to the remote display. The remote display is typically far larger than the mobile device's local display. Thus not only the user of the mobile device, but perhaps many others, can better enjoy information and entertainment, including video gaming, that before was only viewable via the local display.

It is realized herein, however, that this innovative remote display technology comes at the price of high power consumption, which can substantially reduce the battery life of a mobile device. It is also realized herein that power required to provide content to the remote display depends upon the quality of the content, such as its sampling, frame and bit rates. At the same time, it is realized herein that users still desire high-quality video and audio, and that globally reducing its quality is unacceptable.

It is still further realized herein that users want quality as long as they can reasonably have it. It is yet still further realized herein that a suitable compromise between video and audio quality and power consumption might be to maintain quality at a relatively high level until battery life becomes low and only then decrease quality to decrease power consumption and extend battery life.

Mobile devices have power managers that monitor battery life and signal the processor when it is getting low. Conventionally, the processor causes a low-battery icon to be displayed or a low-battery warning alarm to be sounded. It is realized herein, however, that the signal the processor receives may be employed in an unforeseeable and thus novel and nonobvious way, namely to initiate an adjustment of one or more parameters that control the quality of the video, the audio, or both, to reduce power consumption.

Introduced herein are various embodiments of a system and method for extending the battery life of a mobile device that is providing content wirelessly. The embodiments employ a low-battery signal produced by a power manager to prompt an adjustment of one or more parameters that control the encoding of the video and/or the audio that constitute the content that is delivered wirelessly (typically to a remote monitor). In certain embodiments, one or more of the video sampling rate, the video frame rate, the video bit rate, the video resolution, the audio sampling rate and the audio bit rate may be reduced. In other embodiments, a special audio processing mode designed to accommodate transients may be disabled. In yet other embodiments, the adjustment(s) may occur multiple times, such that content quality decrease in stages as battery life decreases. In still other embodiments, the user may configure how and when the content encoding quality is to decrease. In yet still other embodiments, the user may even configure whether the content encoding quality is to decrease.

FIG. 1 is a block diagram illustrating a mobile device 110 providing content wirelessly to a remote display 120. The mobile device 110 may be of any type capable of supporting wireless transmission of content.

In the illustrated embodiment, the mobile device 110 is a smartphone. As those skilled in the pertinent art understand, a smartphone is generally characterized as having a prominent display screen and providing an application programming interface (API) to an operating system (OS) allowing third-party software applications, typically called “apps,” to execute in the smartphone. Examples of current smartphones use the Android, iOS®, Windows® Phone, BlackBerry® or Bada®, Symbian®, Palm OS®, Windows® Mobile™ OS. In an alternative embodiment, the mobile device 110 is a tablet, such as an Apple® iPad®, an Asus® Transformer™, an EVGA™ Tegra®, a Lenovo® Yoga®, an LG® G Pad™, a Panasonic® Toughpad®, a Samsung® Galaxy Note™ or a Microsoft® Surface™. In another alternative embodiment, the mobile device 110 is an e-reader, such as an Amazon® Kindle® or a Barnes & Noble® Nook®. In yet another embodiment, the mobile device 110 is a laptop computer, of which there are many available types.

In the illustrated embodiment, the remote display 120 is a television set provided (or “enabled”) with wireless networking capability. In an alternative embodiment, the remote display 120 is a computer monitor provided with wireless networking capability. In another alternative embodiment, the remote display 120 is a video projector “enabled” with wireless networking capability. Accordingly, the remote display 120 includes a wireless network interface 122.

In the illustrated embodiment, the user of the mobile device 110 can cause the mobile device 110 to determine that the remote display 120 is in range, negotiate a wireless link 130 to the remote display 120 and begin to transmit content in the form of video, audio, or both audio and video, to the remote display 120 via the wireless link 130. The remote display 120 merely displays any video and plays any audio transmitted to it.

Accordingly, the mobile device 110 is operable to provide a video and/or audio stream to the remote display 120 via the wireless link 130. In the illustrated embodiment, the mobile device 110 is operable to take uncompressed (“raw”) video and/or audio data and compress it or them according to an acknowledged wireless standard. In one specific embodiment, the wireless standard for video data is Institute of Electrical and Electronics Engineers (IEEE) H.264, and the standard for audio data is Advanced Audio Coding (AAC). Other embodiments employ other standard or proprietary compression schemes for encoding the video and/or audio transmitted from the mobile device 110. In the case in which both video and audio streams are to be transmitted concurrently, they are multiplexed into a single stream, put into a container format (e.g., MP4, MOV, FLV, WMV or AVI) and transmitted together over the wireless link 130.

FIG. 2 is a high-level block diagram of one embodiment of the mobile device 110 of FIG. 1. The mobile device 110 includes a local display 210, an audio/video subsystem 220, a wireless network interface 230, a processor 240, a memory subsystem 250, a power manager 260 and a battery 270. One or more buses couple the local display 210, the audio/video subsystem 220, the wireless network interface 230, the processor 240, the memory subsystem 250, the power manager 260 and the battery 270 together. The wireless network interface 230 is operable to provide audio and video content wirelessly to a remote display (not shown in FIG. 2). The battery 270 is operable to provide power to the local display 210, the audio/video subsystem 220, the wireless network interface 230, the processor 240, the memory subsystem 250 and the power manager 260.

The power manager 260 is operable to detect a low battery condition and generate a signal indicating that such low battery condition exists. The power manager 260 may, for example, employ known battery characteristics (such as terminal voltage or current) to predict remaining battery life. For example, lead-acid, nickel metal hydride (NiMH), lithium ion (Li-ion) or zinc-based batteries have known voltage and current characteristics that may be employed to predict how much life (i.e. operating time for the mobile device) remains in them. Those skilled in the pertinent art are aware of many existing techniques for determining or predicting remaining battery life, which are outside the scope of this discussion. These conventional techniques, as well as subsequently developed techniques, fall within the broad scope of the invention.

Though it is not always the case, the remaining life of a battery is often expressed as a fraction, usually a percentage, of total life. Assuming this is the case, a low battery condition may be defined as less than 10%, or less than 5% remaining battery life, for example.

In one embodiment, the power manager 260 is operable to generate a signal when the battery condition is such that the battery has less than threshold value of remaining life. Accordingly, the audio/video subsystem 220 is operable to perform a one-time adjustment of one or more parameters when the signal is received. For example, the audio/video subsystem 220 may adjust the one or more parameters to reduce power consumption by virtue of encoding by 15%.

In an alternative embodiment, the power manager 260 is operable to generate multiple signals indicating degrees of low battery condition (e.g., a low battery condition at 10% remaining life, a very low battery condition at 5% remaining life and an immanent battery “death” at 1% remaining life). Accordingly, the audio/video subsystem 220 is operable to make gradual adjustments to the one or more parameters. For example, the audio/video subsystem 220 may adjust the one or more parameters to reduce power consumption by virtue of encoding by 10% under a low battery condition, by 25% under a very low battery condition and by 35% when facing imminent battery “death.” Additional visual or audible warnings may be issued to the user as well.

Some examples of parameters that the audio/video subsystem 220 may adjust will now be described. Example audio parameters will now be addressed.

As those skilled in the pertinent art understand, audio encoders do a psychoacoustic quantization of a raw (uncompressed) audio signal before encoding it. Psychoacoustic quantization is performed by finding masking components on bark band basis, and these masking components make the neighboring frequency components less perceivable as compared to the frequency components that are farther away from the masker. Bits are then allocated to every frequency component by the audio encoder based on how perceivable it is. The amount of quantization an audio encoder performs can be controlled using the bitrate parameter, which is supplied as an input to the encoder. The lower the bitrate parameter is, the larger the amount of quantization and compression (at the expense of signal quality) will be. This reduces the bandwidth required to transmit the audio wirelessly.

The sample rate parameter may be reduced instead or as well. If the rate at which the incoming audio signal is sampled, the computational intensity of the audio encoder will be reduced (at the expense of signal quality) as it is required to process fewer samples every second. This also reduces the bandwidth required to transmit the audio wirelessly.

AAC audio encoders, among others have a transient mode for improving the compression of audio transients. A transient detection algorithm monitors the incoming audio signal and switches the audio encoder between a short window (to capture the transient) and a long window (for overall better frequency resolution). This transient mode can be disabled, such that the long window is always used. Disabling the transient mode yields a couple of benefits at the expense of signal quality. First, disabling the transient mode reduces the computational intensity of the audio encoder. Second, using the long window yields a higher frequency resolution and increases the scope of signal compression, which, in turn, reduce the bandwidth required to transmit the audio wirelessly.

These and other audio parameters may be altered to achieve a lower power consumption either in the encoding or the wireless transmission of the audio, or both. Now example video parameters will be addressed.

Video encoders do a quantization of the incoming raw (uncompressed) video signal before encoding it. As those skilled in the pertinent art understand, a video quantization matrix is designed to provide more resolution to more perceivable frequency components over less perceivable components (usually lower frequencies over high frequencies) in addition to transforming as many components to zero, which can be encoded with greatest efficiency. The lower the bitrate parameter is, the larger the amount of quantization and compression (at the expense of signal quality) will be. This reduces the bandwidth required to transmit the video wirelessly.

The frame rate parameter can also or alternatively be reduced. If the video is encoded at a reduced frame rate (e.g., frames per second instead of 30 frames per second) the computational intensity of encoding by the video encoder will be reduced (at the expense of signal quality). These and other video parameters may be altered to achieve a lower power consumption either in the encoding or the wireless transmission of the video, or both.

FIG. 3 is a flow diagram of one embodiment of a method of extending the battery life of a mobile device that is providing content wirelessly. The method begins in a start step 310. In a step 320, a user is allowed to configure how, when or whether content encoding quality is to decrease. For example, a user may be allowed to configure what remaining battery life (e.g., in terms of percentage) defines a very low battery condition or how much video frame rate may be reduced under very low battery condition. A user may be able to configure. A user may be able to defeat parameter adjustment altogether and suffer the shorter battery life. In some embodiments, factory defaults are provided that the user can override.

In a step 330, one or more parameters controlling an encoding of the content at a relatively high level of quality is set at a relatively high level of quality. For example, the video frame rate parameter may be set at 30 frames per second, and audio sample rate may be set at 48,000 samples per second. Video and audio bit rates may be set at relatively high levels (e.g., 3000 kbps and 192 kbps, respectively), and the audio transient mode may be enabled. In a step 340, a low battery condition (as defined) is detected. In a step 350, in response to the detecting of the low battery condition, least one parameter is adjusted to decrease the quality of the video and/or audio. For example, the video bit rate may be reduced to 2000 kbps, and the audio sample rate may be decreased to 32,000 samples per second. In certain embodiments, multiple levels of low battery condition are detected, and evermore severe adjustments of parameters are made. For example, an initial video bit rate of 3500 kbps may be decreased to 2500 kpbs, then 150 kbps at a later time, then 1000 kpbs near the end of the battery life. The method ends in an end step 360.

In certain embodiments, one or more of the parameters are adjusted upward if battery life lengthens (typically because the mobile device has been plugged into a charger. Thus, video resolution may be increased from 640×360 to 1920×1080 high definition (HD) when battery life lengthens. Thus, content quality may be made to vary directly as a function of battery life.

Those skilled in the art to which this application relates will appreciate that other and further additions, deletions, substitutions and modifications may be made to the described embodiments.

What is claimed is:

1. A system for extending the battery life of a mobile device providing content wirelessly, comprising:
a power manager operable to generate a signal indicating that a low battery condition exists; and
an audio/video subsystem operable to receive said signal and adjust at least one parameter controlling an encoding of said content to decrease a quality of said encoding.

2. The system as recited in claim 1 wherein said audio/video subsystem is further operable to adjust at least one video parameter selected from the group consisting of:
a frame rate, and
a bit rate.

3. The system as recited in claim 1 wherein said audio/video subsystem is further operable to adjust at least one audio parameter selected from the group consisting of:
a sampling rate, and
a bit rate.

4. The system as recited in claim 1 wherein said audio/video subsystem is further operable to disable a transient mode of an audio encoder.

5. The system as recited in claim 1 wherein said power manager is further operable to generate signals indicating degrees of low battery condition and said audio/video subsystem is further operable to receive said signals and adjust said at least one parameter gradually to decrease said quality of said encoding.

6. The system as recited in claim 5 wherein said audio/video subsystem is further operable to adjust said at least one parameter according to a user configuration.

7. The system as recited in claim 1 wherein said audio/video subsystem comprises an H.264 video encoder and an AAC audio encoder.

8. A method of extending the battery life of a mobile device providing content wirelessly, comprising:
initially setting at least one parameter controlling an encoding of said content at a relatively high level of quality;
detecting when a low battery condition exists; and
in response to said detecting, adjusting said least one parameter to decrease said quality.

9. The method as recited in claim 8 wherein said at least one parameter is at least one video parameter selected from the group consisting of:
a frame rate, and
a bit rate.

10. The method as recited in claim 8 wherein said at least one parameter is at least one audio parameter selected from the group consisting of:
a sampling rate, and
a bit rate.

11. The method as recited in claim 8 wherein said adjusting comprises disabling a transient mode of an audio encoder.

12. The method as recited in claim 8 wherein said detecting comprises detecting degrees of low battery condition and said adjusting comprises adjusting said at least one parameter gradually to decrease said quality of said encoding.

13. The method as recited in claim 12 further comprising allowing a user to configure how, when or whether said quality is to decrease.

14. The method as recited in claim 8 wherein said at least one parameter pertains to H.264 video encoding and AAC audio encoding.

15. A mobile device, comprising:
a local display;
a wireless network interface operable to provide audio and video content wirelessly to a remote display;
a processor coupled to said local display and said wireless network interface;
a memory subsystem coupled to said processor;
a power manager coupled to said processor and operable to generate a signal indicating that a low battery condition exists; and
an audio/video subsystem operable to provide said audio and video content to said wireless network interface, receive said signal and adjust at least one parameter controlling an encoding of said video and audio content to decrease a quality of said encoding.

16. The mobile device as recited in claim 15 wherein said audio/video subsystem is further operable to adjust at least one video parameter selected from the group consisting of:
a frame rate, and
a bit rate.

17. The mobile device as recited in claim 15 wherein said audio/video subsystem is further operable to adjust at least one audio parameter selected from the group consisting of:
a sampling rate, and
a bit rate.

18. The mobile device as recited in claim 15 wherein said audio/video subsystem is further operable to disable a transient mode of an audio encoder.

19. The mobile device as recited in claim 15 wherein said power manager is further operable to generate signals indicating degrees of low battery condition and said audio/video subsystem is further operable to receive said signals and adjust said at least one parameter gradually to decrease said quality of said encoding.

20. The mobile device as recited in claim 15 wherein said audio/video subsystem is further operable to adjust said at least one parameter according to a user configuration.
